(19) United States
(12) Patent Application Publication
(10) Pub. No.: US 2026/0111752 A1
(43) Pub. Date: Apr. 23, 2026

(54) TECHNIQUES FOR SELF-ASSESSING A GENERATIVE LANGUAGE MODEL

(71) Applicant: Microsoft Technology Licensing, LLC, Redmond, WA (US)

(72) Inventors: Xuchao ZHANG, Sammamish, WA (US); Saravanakumar Rajmohan, Redmond, WA (US); Chetan Bansal, Seattle, WA (US); Shivam Shandilya, SuPaul (IN); Taneesh Gupta, Kanpur (IN); Supriyo Ghosh, Bangalore (IN)

(21) Appl. No.: 18/985,433

(22) Filed: Dec. 18, 2024

(30) Foreign Application Priority Data
Oct. 23, 2024 (IN) 202441080675

(51) Int. Cl. G06N 3/096; G06N 3/045; G06N 3/0475

(52) U.S. Cl. CPC G06N 3/096; G06N 3/045; G06N 3/0475

(57) ABSTRACT

Described herein are techniques for evaluating large language model outputs through autonomous generation of context-aware evaluation criteria without relying on static human-defined standards. The approach enables dynamic generation of evaluation criteria tailored to specific instructions and responses, while incorporating context-specific knowledge crucial for accurate assessment. A framework implements both absolute evaluation against reference answers and relative comparison between multiple responses. Knowledge distillation techniques create efficient smaller models capable of criteria generation and evaluation with performance comparable to larger models. The technique demonstrates significant improvements in evaluation accuracy across diverse tasks while reducing computational costs through optimized model architectures. Additionally, the approach enhances preference-based learning through dynamically generated evaluation criteria, improving model alignment with human judgment.

### RELATED APPLICATIONS

This application claims the benefit under 35 U.S.C. § 119(a) of Indian Provisional Patent Application No. 202441080675, filed Oct. 23, 2024, entitled “LLM AS A JUDGE with CONTEXT AWARE CRITERIA,” which is hereby incorporated by reference in its entirety.

### TECHNICAL FIELD

The present disclosure relates generally to language model evaluation frameworks, and more particularly to techniques for autonomous generation of context-aware evaluation criteria for assessing large language model (LLM) outputs. Specifically, the disclosure describes approaches for enabling generative language models to dynamically generate and apply evaluation criteria without relying on predefined human standards, while incorporating context-specific knowledge for accurate assessment. The disclosure further relates to knowledge distillation techniques for creating efficient, smaller language models capable of generating evaluation criteria and performing assessments with performance comparable to larger models. The technical field encompasses artificial intelligence, machine learning, and specifically the development of self-assessing language model frameworks that can autonomously evaluate responses across diverse tasks while addressing challenges in scalability, cost-effectiveness, and contextual adaptation. The disclosure additionally relates to preference optimization through dynamically generated evaluation criteria to enhance language model performance and alignment with human judgment.

### BACKGROUND

Advances in artificial intelligence (AI), particularly in the field of natural language processing (NLP), have enabled the development of generative language models, including large language models (LLMs) capable of generating highly coherent and contextually relevant text. These models have found applications in a wide array of domains, including content creation, summarization, translation, and conversational interfaces. However, evaluating the performance of LLMs remains a significant challenge due to the inherent subjectivity of language and the difficulty of quantifying qualitative aspects such as relevance, coherence, and creativity.

Evaluating machine-generated text has emerged as a significant challenge in natural language processing, particularly as LLMs have grown increasingly sophisticated. Traditional evaluation metrics like BLEU and ROUGE, which focus on lexical analysis, and more recent approaches like BERTScore and BARTScore for semantic evaluation, often fail to fully capture the nuanced aspects of human judgment when assessing generated text.

While LLM-based evaluators have shown promise in aligning with human judgments through zero-shot and few-shot instruction approaches, current evaluation frameworks face significant limitations. These evaluators typically rely on static, predefined criteria that are applied uniformly across all evaluation instances, regardless of the specific context or requirements of individual tasks. This rigid approach struggles to generalize effectively across diverse types of text generation tasks.

### BRIEF DESCRIPTION OF THE DRAWINGS

Embodiments of the present invention are illustrated by way of example and not limitation in the figures of the accompanying drawings, in which:

FIG. 1 illustrates example inputs used to establish self-assessing criteria for evaluating machine-generated text, including an instruction requesting summarization, a reference answer, and a response, along with autonomously generated evaluation factors, consistent with some embodiments.

FIG. 2 illustrates an absolute evaluation approach for assessing text output generated by a first generative language model, showing the criteria generation stage using a second generative language model and the evaluation stage using a third generative language model consistent with some embodiments.

FIG. 3 illustrates a relative evaluation approach for assessing and comparing multiple responses to the same instruction, showing the criteria generation stage, evaluation stage, and preference data generation process, consistent with some embodiments.

FIG. 4 is a block diagram illustrating an example of a computing device with which embodiments of the present invention might be implemented.

### DETAILED DESCRIPTION

Described herein are methods and systems for evaluating text output generated by large language models (LLMs) using dynamically generated, context-aware evaluation criteria. The methods and systems enable autonomous generation of evaluation factors tailored to specific evaluation tasks, without relying on human-generated, static, predefined criteria sets. In the following description, for purposes of explanation, numerous specific details are set forth to provide a thorough understanding of the various aspects of different embodiments of the present invention. These details include methods for generating task-specific evaluation factors, techniques for applying these factors to assess machine-generated text, and approaches for fine-tuning smaller language models to perform efficient evaluations. It will be evident, however, to one skilled in the art that the present invention may be practiced without all of these specific details.

The technical challenges in evaluating machine-generated text have become increasingly complex with the advancement of generative language models, including LLMs Current evaluation approaches face several critical technical limitations that impact their effectiveness and reliability. One fundamental technical problem lies in the static nature of existing evaluation frameworks. These frameworks typically rely on predefined criteria sets that are applied uniformly across all evaluation instances, regardless of the specific requirements or context of individual tasks. This rigid approach creates significant technical constraints when attempting to evaluate responses that require varying levels of analytical depth or domain-specific understanding.

For example, when evaluating a response about climate change impacts on polar bear populations, traditional evaluation methods using static criteria might only verify the presence of basic concepts like “climate change” and “melting ice.” However, these methods lack the technical capability to assess whether the response provides sufficient explanation of critical cause-and-effect relationships, such as how habitat loss specifically affects hunting practices and energy expenditure. This technical limitation results in incomplete and potentially misleading evaluations.

The technical challenge is further compounded by the diverse nature of generative tasks that LLMs are expected to perform. Each task may require different evaluation criteria based on factors such as complexity, domain specificity, and intended audience. Current evaluation frameworks lack the technical mechanisms to dynamically adjust their assessment criteria based on these contextual factors. This limitation becomes particularly apparent when evaluating responses that demand varying levels of technical depth or domain expertise.

Traditional evaluation metrics like BLEU and ROUGE present additional technical constraints due to their focus on surface-level lexical analysis. While these metrics provide quantifiable measurements, they fail to capture the nuanced aspects of language generation that human evaluators naturally consider. Similarly, more advanced semantic evaluation methods like BERTScore and BARTScore, while offering improvements over lexical metrics, still fall short of providing comprehensive evaluation capabilities that can adapt to diverse evaluation contexts.

Recent attempts to use LLMs as evaluators have introduced new technical complexities. While these approaches can leverage the ability of an LLM to follow human-prepared criteria, they remain constrained by their reliance on static, predefined evaluation rubrics. This technical limitation prevents them from effectively generalizing across diverse tasks and fails to provide the context-aware evaluation capabilities necessary for accurate assessment of machine-generated text.

The challenges extend to the scalability and consistency of evaluations. Current approaches either require resource-intensive human evaluation or rely on simplified automated metrics that cannot capture the full complexity of language generation. This creates a technical barrier to achieving reliable, consistent, and scalable evaluation of LLM outputs across different contexts and applications.

These limitations highlight the need for a more sophisticated approach to evaluation that can dynamically generate and apply evaluation criteria based on the specific requirements of each task and context. Such an approach must be capable of autonomously determining relevant evaluation factors while maintaining consistency and reliability across diverse evaluation scenarios.

In various embodiments, the present invention provides methods and systems for evaluating text output generated by a first generative language model in response to a user query. The system employs a second generative language model to generate evaluation factors based on an input prompt that includes the user query, the text output generated by the first model to be evaluated, and a reference response. These dynamically generated factors are then used by a third generative language model to produce a detailed evaluation, including specific feedback and numerical scores that assess how well the text output by the first model satisfies each evaluation factor.

The first, second, and third generative language models may represent different model architectures (e.g., GPT-4, LLaMA, Mistral) or may be different instances of the same model architecture. For example, in some embodiments, the second and third generative language models are separate instances of GPT-4, while in other embodiments, the second model may be GPT-4 and the third model may be LLaMA-13B. Additionally, through knowledge distillation techniques, the capabilities of larger models like GPT-4 can be transferred to smaller, more efficient models like LLaMA-7B or Mistral-7B while maintaining comparable evaluation performance.

In certain embodiments, the second and third generative language models are implemented as separate instances of the same generative language model, wherein the same model is configured to both generate the evaluation factors and perform the evaluation. This approach enables efficient resource utilization while maintaining consistent evaluation quality across the generation of factors and their application in assessment.

In the relative evaluation setting, the system compares multiple responses to the same user query without requiring a reference response. The second generative language model generates context-specific evaluation factors based on the instruction and the responses being compared. The third generative language model then applies these factors to assess the relative quality of the responses, producing comparative feedback and determining which response better satisfies the evaluation criteria.

Both absolute and relative evaluation embodiments leverage the ability of the system to autonomously generate evaluation factors tailored to the specific context of each evaluation task. This dynamic approach enables more nuanced assessment compared to traditional methods that rely on static, predefined criteria. The system can identify and evaluate subtle aspects of responses that might be overlooked by conventional evaluation frameworks, such as the depth of explanation in complex topics or the appropriateness of detail level for the intended audience.

Consistent with some embodiments, the system incorporates knowledge distillation techniques to create more efficient implementations. Larger generative language models are used to generate evaluation factors and perform initial assessments, with their capabilities then being transferred to smaller, more efficient models through fine-tuning. This approach maintains evaluation quality while reducing computational requirements, enabling more scalable deployment of the evaluation framework.

The flexibility of the system allows it to adapt to diverse evaluation scenarios while maintaining consistency and reliability. Whether performing absolute evaluation against reference responses or relative comparison between multiple outputs, the framework generates appropriate evaluation factors that capture the specific requirements and nuances of each evaluation task.

The described framework represents a significant advancement in the field of machine learning evaluation technology, particularly in addressing the technical challenges of assessing large language model outputs. By dynamically generating evaluation criteria rather than selecting from predefined rubrics, this approach overcomes fundamental limitations in existing evaluation systems. The autonomous generation of context-aware evaluation factors enables more precise and nuanced assessments across diverse tasks, while the incorporation of knowledge distillation techniques allows the deployment of smaller, more efficient models without sacrificing evaluation quality. This technical improvement yields several concrete advantages: enhanced scalability through reduced computational requirements, improved evaluation accuracy through task-specific criteria generation, and increased reliability through consistent application of dynamically generated evaluation factors. The framework's ability to adapt its evaluation approach based on task complexity and domain specificity represents a substantial technical advancement over traditional evaluation methods that rely on static metrics or simplified automated scoring systems. Other aspects and advantages of the various embodiments of the innovative techniques set forth herein will be readily apparent from the description of the several figures that follows.

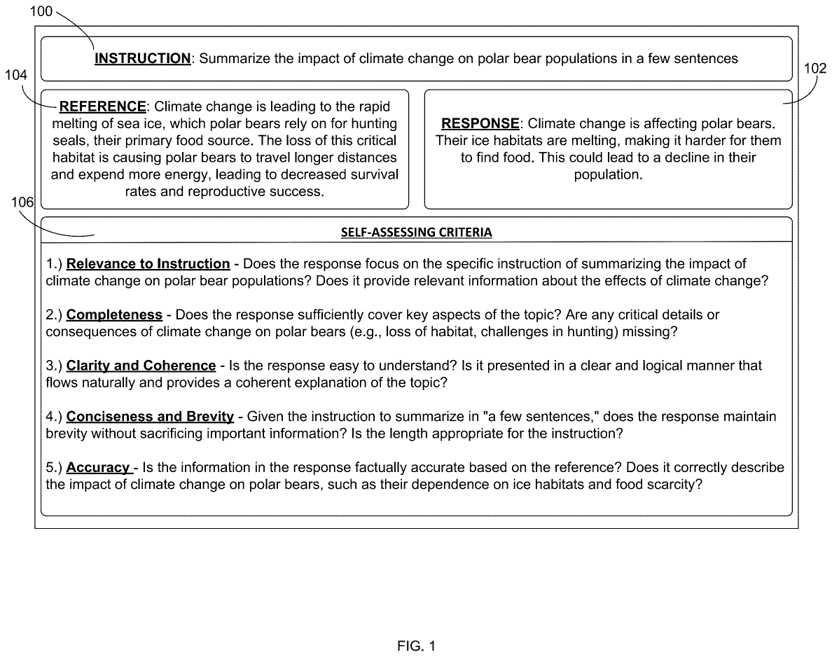

FIG. 1 illustrates example inputs used to establish self-assessing criteria for evaluating machine-generated text, consistent with some embodiments. The illustration shows an instruction 100 requesting summarization of climate change impacts on polar bear populations. A reference answer 104 provides an exemplary high-quality response that describes how melting sea ice affects polar bear hunting and survival. A response 102 represents text output generated by a language model in response to the instruction 100.

Based on these three inputs—the instruction 100, reference answer 102, and generated response 104—the framework generates a set of self-assessing criteria 106. The illustration shows five specific evaluation factors that were autonomously generated to assess the response quality. In this example, these include criteria examining: (1) relevance to the instruction, (2) completeness of coverage, (3) clarity and coherence of presentation, (4) conciseness relative to the requested length, and (5) factual accuracy compared to the reference. Each criterion is formulated as a detailed analytical question to enable systematic assessment.

The example inputs and resulting criteria 106 demonstrate how the framework analyzes the specific instruction, reference, and response to generate evaluation factors uniquely tailored to assess the particular task and domain. Rather than applying pre-existing criteria, the framework derives assessment factors based on the contextual requirements evident in these inputs.

The example inputs illustrated in FIG. 1 may be obtained from various sources. In some embodiments, the instruction 100, reference answer 102, and response 104 may be part of an existing feedback collection dataset used for training and evaluating language models. In other embodiments, these inputs may be dynamically generated during real-time evaluation scenarios, such as when assessing model outputs in production environments. The instruction may come from actual user queries, the reference answer may be provided by domain experts or curated from high-quality sources, and the response may be generated on-demand by the first generative language model being evaluated. Additionally, the inputs may be derived from existing evaluation benchmarks, such as Vicuna Bench, MT-Bench, Flask Eval, or Alpaca Eval, which provide diverse sets of instructions and reference answers across different domains and task types.

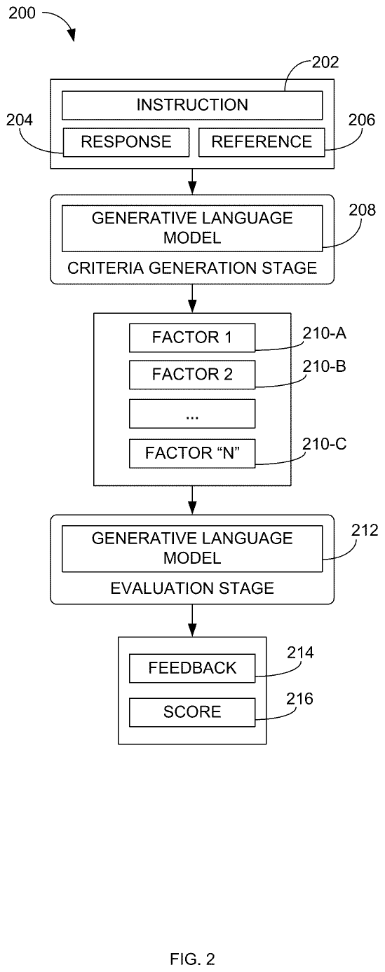

FIG. 2 illustrates one embodiment of the evaluation framework, specifically showing an absolute evaluation approach for assessing text output generated by a first generative language model (e.g., an LLM). Unlike the relative evaluation approach (described below) that compares multiple text outputs from language models, this embodiment evaluates a single model-generated response against a reference answer to assess its quality.

As shown in FIG. 2, the evaluation framework or system receives several inputs at the criteria generation stage: an instruction 202 specifying the task to be performed by the first generative language model, a response 204 that was generated by the first generative language model in response to that instruction, and a reference answer 206 representing an ideal response. These inputs are processed by a second generative language model 208, which may be implemented using various model architectures or as a fine-tuned smaller model. The second model 208 analyzes these inputs to generate multiple evaluation factors (210-A, 210-B, 210-C) specifically tailored to assess different aspects of the quality of the response 204, as generated by the first language model (not shown).

In the evaluation stage, a third generative language model 212 receives the generated evaluation factors along with the instruction and the response 204 of the first model that is to be evaluated. This third generative language model, which may be implemented as a separate model architecture or as a fine-tuned model, processes these inputs to generate both detailed feedback 214 and a numerical score 216. The feedback 214 provides specific assessments of how well the response 204 from the first model satisfies each evaluation factor, while the score 216 quantifies the overall quality of the generated response 204.

This evaluation framework supports various implementations of the generative language models used in both stages. In some embodiments, the second and third models (208 and 212) may be separate instances of the same generative language model, configured to perform both criteria generation and evaluation tasks. These models may also be fine-tuned versions of larger models, created through knowledge distillation techniques (described below) to achieve efficient performance with fewer parameters while maintaining the ability to effectively evaluate the first model's output.

The evaluation process of the first model's output may be conducted through different approaches. In some embodiments, the third model 212 processes all factors simultaneously to generate comprehensive feedback and scoring. In other embodiments, the model iteratively processes separate prompts for each evaluation factor, generating factor-specific assessments of the first model's response that are then combined to produce the final evaluation. The framework may also incorporate weighted scoring, where each evaluation factor is assigned a weighted score that contributes to the final evaluation based on factor-specific weights determined by the third model.

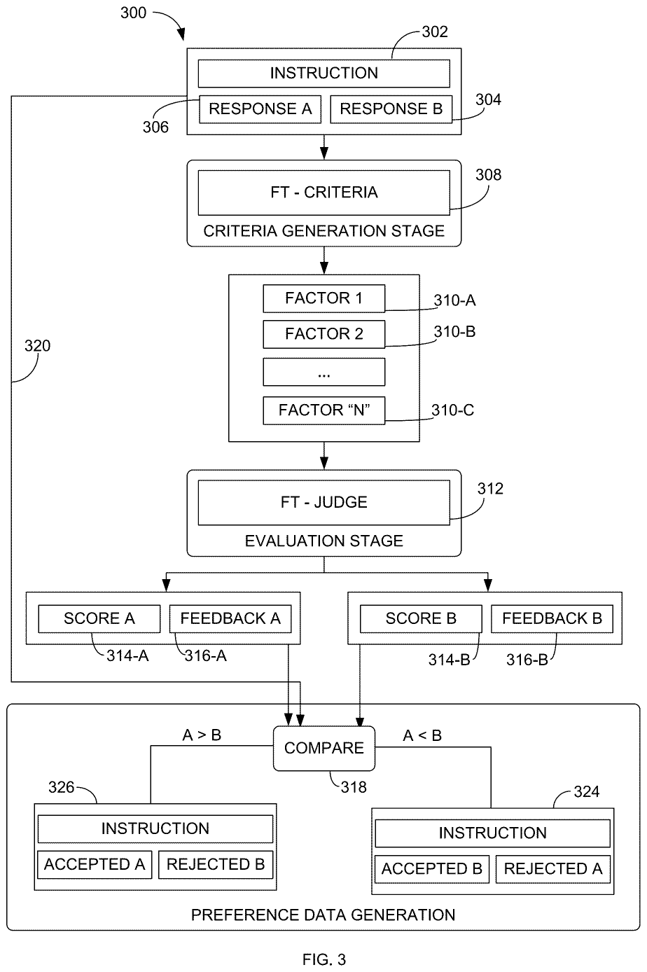

FIG. 3 illustrates an embodiment implementing a relative evaluation approach for assessing and comparing multiple responses to the same instruction. In this relative setting, the framework evaluates the relative quality of different responses without requiring a reference answer, enabling direct comparison of outputs that may be generated by either the same or different language models.

As shown in FIG. 3, the framework receives an instruction 302 and two responses to be compared: Response A 306 and Response B 304. These responses may be generated by the same language model using different parameters or approaches, or they may come from entirely different model architectures. The responses are processed by a fine-tuned criteria model (FT-Criteria) 308, which generates evaluation factors (310-A, 310-B, 310-C) specifically tailored to assess and compare the relative strengths and weaknesses of the responses.

In the evaluation stage, a fine-tuned judge model (FT-Judge) 312 processes the instruction, responses, and generated evaluation factors to produce detailed feedback and scores for each response. For Response A, the model generates Score A 314-A and Feedback A 316-A, while for Response B, it generates Score B 314-B and Feedback B 316-B. These evaluations assess how well each response satisfies the generated criteria.

The framework then performs a comparison 318 of the evaluations to determine which response better satisfies the criteria. Based on this comparison, the framework generates preference data, which includes both accepted and rejected responses. If Response A is determined to be superior, the framework generates an instruction 324 paired with Response A as the accepted response and Response B as the rejected response. Conversely, if Response B is deemed better, the framework generates an instruction 326 paired with Response B as the accepted response and Response A as the rejected response.

This preference data generation capability makes the framework particularly valuable for training and fine-tuning language models through direct preference optimization techniques. The dynamically generated evaluation criteria ensure that the preference judgments are based on task-specific factors rather than static, predefined metrics.

The framework employs knowledge distillation techniques to create efficient, smaller language models capable of performing both criteria generation and evaluation tasks. This process involves using a larger model, such as GPT-4, as a teacher model to train smaller, more efficient student models that can achieve comparable performance with significantly fewer parameters.

For training the criteria generation model (FT-Criteria 308), the framework first utilizes a feedback collection dataset containing diverse instructions, responses, and reference answers. The larger teacher model, such as GPT-4, processes each instance in this dataset to generate evaluation criteria. These generated criteria, along with the original instructions, responses, and references, form a new training dataset. This dataset is then used to fine-tune a smaller language model, such as LLaMA-7B or LLaMA-13B, enabling it to generate evaluation criteria similar to those produced by the larger model.

Similarly, for training the evaluation model (FT-Judge 312), the framework leverages the feedback and scores generated by the larger model based on the dynamically generated criteria. The teacher model processes each instance in the dataset, producing detailed feedback and numerical scores that assess how well responses satisfy the generated criteria. This evaluation data is used to fine-tune another instance of a smaller language model, enabling it to perform evaluations with performance comparable to the larger model while using fewer computational resources.

The fine-tuning process incorporates various optimization techniques to ensure efficient knowledge transfer. For standard fine-tuning, the framework may employ, in some examples, a learning rate of 1×10\hat{ }-5, while for direct preference optimization fine-tuning, a lower learning rate of 1×10\hat{ }-6 is used to ensure stable training. The training process typically involves multiple epochs with a batch size of 64, and implements a cosine annealing learning rate scheduler to optimize the learning process.

In some instances, the fine-tuned smaller models achieve performance comparable to or superior to larger models while requiring significantly fewer computational resources. For example, fine-tuned models using only 13B parameters, in some examples, have shown the ability to outperform many state-of-the-art open-source models that typically operate with much larger architectures (e.g., 175B parameters). This efficiency gain makes the framework highly competitive in terms of both performance and scalability.

The framework supports fine-tuning different model architectures, including but not limited to LLaMA-7B, LLaMA-13B, Mistral-7B, and similar efficient model architectures. The choice of specific architecture can be adapted based on computational resources and performance requirements, with the framework maintaining consistent evaluation quality across different implementations.

### Machine and Software Architecture

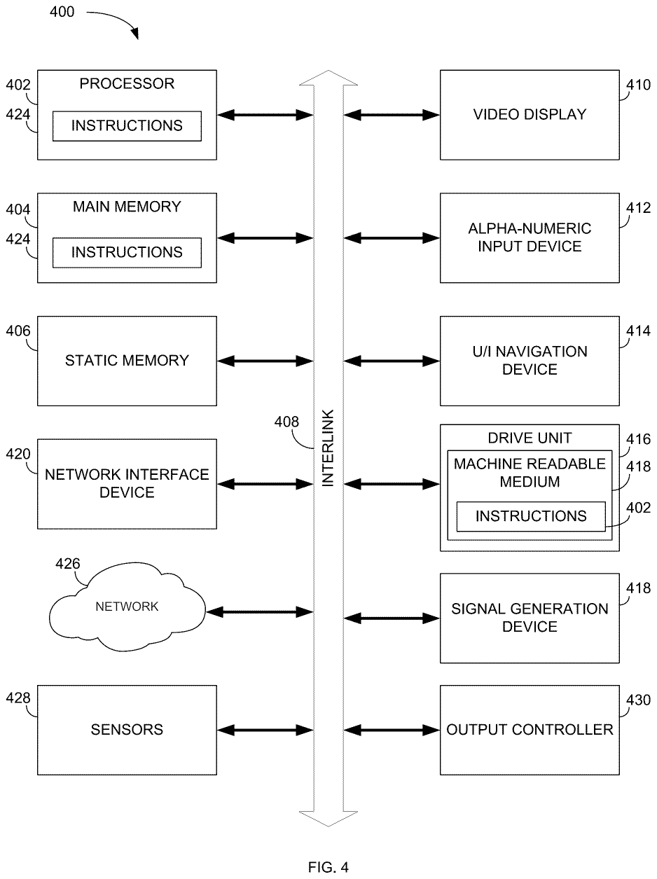

FIG. 4 illustrates a block diagram of an example machine 400 upon which any one or more of the techniques (e.g., methodologies) discussed herein may be performed. In alternative embodiments, the machine 400 may operate as a standalone device or may be connected (e.g., networked) to other machines. In a networked deployment, the machine 400 may operate in the capacity of a server machine, a client machine, or both in server-client network environments. In an example, the machine 400 may act as a peer machine in peer-to-peer (P2P) (or other distributed) network environment. The machine 400 may be in the form of a server, desktop, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. Machine 400 may be configured to implement the disclosed Self Assessing LLMs with Autonomous Criterion (SALC) generation framework.

Examples, as described herein, may include, or may operate on one or more logic units, components, or mechanisms (hereinafter “components”). Components are tangible entities (e.g., hardware) capable of performing specified operations and may be configured or arranged in a certain manner. In an example, circuits may be arranged (e.g., internally or with respect to external entities such as other circuits) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations.

In an example, the software may reside on a machine readable medium. In an example, the software, when executed by the underlying hardware of the component, causes the hardware to perform the specified operations of the component. Accordingly, the term “component” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which component are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular module at one instance of time and to constitute a different component at a different instance of time.

Machine (e.g., computer system) 400 may include one or more hardware processors, such as processor 402. Processor 402 may be a central processing unit (CPU), a graphics processing unit (GPU), a hardware processor core, or any combination thereof. Machine 400 may include a main memory 404 and a static memory 406, some or all of which may communicate with each other via an interlink (e.g., bus) 408. Examples of main memory 404 may include Synchronous Dynamic Random-Access Memory (SDRAM), such as Double Data Rate memory, such as DDR4 or DDR5.

Interlink 408 may be one or more different types of interlinks such that one or more components may be connected using a first type of interlink and one or more components may be connected using a second type of interlink. Example interlinks may include a memory bus, a peripheral component interconnect (PCI), a peripheral component interconnect express (PCIe) bus, a universal serial bus (USB), or the like. The machine 400 may further include a video display unit 410, an alphanumeric input device 412 (e.g., a keyboard), and a user interface (UI) navigation device 414 (e.g., a mouse, or similar). In an example, the display unit 410, input device 412 and UI navigation device 414 may be a touch screen display.

The machine 400 may additionally include a storage device (e.g., drive unit) 416, a signal generation device 418 (e.g., a speaker), a network interface device 420, and one or more sensors 428, such as a global positioning system (GPS) sensor, compass, accelerometer, or other sensor. The machine 400 may include an output controller 430, such as a serial (e.g., universal serial bus (USB), parallel, or other wired or wireless (e.g., infrared(IR), near field communication (NFC), etc.) connection to communicate or control one or more peripheral devices (e.g., a printer, card reader, etc.).

The storage device 416 may include a machine readable medium 422 on which is stored one or more sets of data structures or instructions 424 (e.g., software) embodying or utilized by any one or more of the techniques or functions described herein. The instructions 424 may also reside, completely or at least partially, within the main memory 404, within static memory 406, or within the hardware processor 402 during execution thereof by the machine 400. In an example, one or any combination of the hardware processor 402, the main memory 704, the static memory 706, or he storage device 716 may constitute machine readable media. While the machine readable medium 722 is illustrated as a single medium, the term “machine readable medium” may include a single medium or multiple media (e.g., a centralized or distributed database, and/or associated caches and servers) configured to store the one or more instructions 724.

The term “machine readable medium” may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal. The instructions 724 may further be transmitted or received over a communications network 726 using a transmission medium via the network interface device 720. The Machine 700 may communicate with one or more other machines wired or wirelessly utilizing any one of a number of transfer protocols (e.g., frame relay, internet protocol (IP), transmission control protocol (TCP), user datagram protocol (UDP), hypertext transfer protocol (HTTP), etc.).

Example communication networks may include a local area network (LAN), a wide area network (WAN), a packet data network (e.g., the Internet), mobile telephone networks (e.g., cellular networks), Plain Old Telephone (POTS) networks, and wireless data networks such as an Institute of Electrical and Electronics Engineers (IEEE) 802.11 family of standards known as Wi-Fi®, an IEEE 802.15.4 family of standards, a 5G New Radio (NR) family of standards, a Long Term Evolution (LTE) family of standards, a Universal Mobile Telecommunications System (UMTS) family of standards, peer-to-peer (P2P) networks, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SIMO), multiple-input multiple-output (MIMO), or multiple-input single-output (MISO) techniques. In some examples, the network interface device 720 may wirelessly communicate using Multiple User MIMO techniques.

What is claimed is:

1. A method for evaluating text output by a first generative language model in response to a user query, the method comprising:
generating, by a second generative language model, a plurality of evaluation factors based on a first input prompt comprising:
a system instruction to generate evaluation factors for evaluate the text output;
the user query;
the text output by the first generative language model in response to the user query; and
a reference response to the user query;
generating, by a third generative language model, an evaluation of the text output by the first generative language model, based on a second input prompt comprising:
the plurality of evaluation factors generated by the second generative language model;
the text output by the first generative language model in response to the user query; and
an instruction to evaluate the text output in response to the user query using the plurality of evaluation factors; and
outputting the evaluation generated by the third generative language model.

2. The method of claim 1, wherein the instruction to evaluate the text output in the second input prompt instructs the third generative language model to:
generate detailed feedback for each of the plurality of evaluation factors; and
assign a score within a predetermined range based on how well the text output satisfies the plurality of evaluation factors.

3. The method of claim 1, wherein generating the evaluation by the third generative language model comprises:
generating a weighted score for each of the plurality of evaluation factors;
combining the weighted scores according to factor-specific weights determined by the third generative language model; and
producing a final evaluation score based on the weighted combination.

4. The method of claim 1, wherein the second generative language model and the third generative language model are separate instances of a same generative language model, wherein the same generative language model is configured to both:
generate the plurality of evaluation factors based on the first input prompt; and
generate the evaluation based on the second input prompt.

5. The method of claim 1, further comprising:
fine-tuning a fourth generative language model to generate evaluation criteria by:
generating evaluation criteria and feedback using a fifth generative language model on a feedback collection dataset;
using the generated evaluation criteria and feedback to train the fourth generative language model to generate evaluation criteria; and
fine-tuning a sixth generative language model to evaluate text output by:
using the feedback and scores generated by the fifth generative language model to train the sixth generative language model to perform evaluations, wherein the fine-tuned fourth and sixth generative language models are trained to achieve superior performance to the fifth generative language model while using fewer model parameters.

6. The method of claim 5, wherein the fourth generative language model and the sixth generative language model are separate instances of a same generative language model having fewer model parameters than the generative language model corresponding to the fifth generative language model.

7. The method of claim 1, wherein generating the evaluation by the third generative language model comprises:
iteratively processing a series of separate prompts, wherein:
each prompt corresponds to a different one of the plurality of evaluation factors;
each prompt includes the text output by the first generative language model;
each prompt instructs the third generative language model to evaluate the text output specifically with respect to its corresponding evaluation factor; and
combining the evaluations from the series of separate prompts to generate the evaluation of the text output.

8. The method of claim 1, further comprising:
fine-tuning a fourth generative language model to perform the generating of evaluation factors by:
receiving a plurality of triplets, each triplet comprising (i) an instruction, (ii) a response generated by the first generative language model based on the instruction, and (iii) a reference response;
generating, by the second generative language model, evaluation factors and feedback for the plurality of triplets;
training the fourth generative language model using knowledge distillation techniques to generate evaluation factors based on the evaluation factors generated by the second generative language model, wherein the fourth generative language model has fewer model parameters than the second generative language model.

9. The method of claim 8, further comprising:
fine-tuning a fifth generative language model to perform the generating of evaluations by:
receiving a plurality of triplets, each triplet comprising (i) an instruction, (ii) a response generated by the first generative language model based on the instruction, and (iii) a reference response;
generating, by the third generative language model, feedback and scores for the plurality of triplets;
training the fifth generative language model using knowledge distillation techniques to generate evaluations based on the feedback and scores generated by the third generative language model, wherein the fifth generative language model has fewer model parameters than the third generative language model.

10. A system for evaluating text output by a first generative language model in response to a user query, the system comprising:
one or more processors; and
memory storing instructions that, when executed by the one or more processors, cause the system to:
generate, by a second generative language model, a plurality of evaluation factors based on a first input prompt comprising:
a system instruction to generate evaluation factors for evaluating the text output;
the user query;
the text output by the first generative language model in response to the user query; and
a reference response to the user query;
generate, by a third generative language model, an evaluation of the text output by the first generative language model, based on a second input prompt comprising:
the plurality of evaluation factors generated by the second generative language model;
the text output by the first generative language model in response to the user query; and
an instruction to evaluate the text output in response to the user query using the plurality of evaluation factors; and
output the evaluation generated by the third generative language model.

11. The system of claim 10, wherein the instruction to evaluate the text output in the second input prompt instructs the third generative language model to:
generate detailed feedback for each of the plurality of evaluation factors; and
assign a score within a predetermined range based on how well the text output satisfies the plurality of evaluation factors.

12. The system of claim 10, wherein generating the evaluation by the third generative language model comprises:
generating a weighted score for each of the plurality of evaluation factors;
combining the weighted scores according to factor-specific weights determined by the third generative language model; and
producing a final evaluation score based on the weighted combination.

13. The system of claim 10, wherein the second generative language model and the third generative language model are separate instances of a same generative language model, wherein the same generative language model is configured to both:
generate the plurality of evaluation factors based on the first input prompt; and
generate the evaluation based on the second input prompt.

14. The system of claim 10, wherein the instructions further cause the system to:
fine-tune a fourth generative language model to generate evaluation criteria by:
generating evaluation criteria and feedback using a fifth generative language model on a feedback collection dataset;
using the generated evaluation criteria and feedback to train the fourth generative language model to generate evaluation criteria; and
fine-tune a sixth generative language model to evaluate text output by:
using the feedback and scores generated by the fifth generative language model to train the sixth generative language model to perform evaluations, wherein the fine-tuned fourth and sixth generative language models are trained to achieve superior performance to the fifth generative language model while using fewer model parameters.

15. The system of claim 14, wherein the fourth generative language model and the sixth generative language model are separate instances of a same generative language model having fewer model parameters than the generative language model corresponding to the fifth generative language model.

16. The system of claim 10, wherein generating the evaluation by the third generative language model comprises:
iteratively processing a series of separate prompts, wherein:
each prompt corresponds to a different one of the plurality of evaluation factors;
each prompt includes the text output by the first generative language model;
each prompt instructs the third generative language model to evaluate the text output specifically with respect to its corresponding evaluation factor; and
combining the evaluations from the series of separate prompts to generate the evaluation of the text output.

17. The system of claim 10, wherein the instructions further cause the system to:
fine-tune a fourth generative language model to perform the generating of evaluation factors by:
receiving a plurality of triplets, each triplet comprising (i) an instruction, (ii) a response generated by the first generative language model based on the instruction, and (iii) a reference response;
generating, by the second generative language model, evaluation factors and feedback for the plurality of triplets;
training the fourth generative language model using knowledge distillation techniques to generate evaluation factors based on the evaluation factors generated by the second generative language model, wherein the fourth generative language model has fewer model parameters than the second generative language model.

18. The system of claim 17, wherein the instructions further cause the system to:
fine-tune a fifth generative language model to perform the generating of evaluations by:
receiving a plurality of triplets, each triplet comprising (i) an instruction, (ii) a response generated by the first generative language model based on the instruction, and (iii) a reference response;
generating, by the third generative language model, feedback and scores for the plurality of triplets;
training the fifth generative language model using knowledge distillation techniques to generate evaluations based on the feedback and scores generated by the third generative language model, wherein the fifth generative language model has fewer model parameters than the third generative language model.

19. A non-transitory machine-readable medium storing instructions that, when executed by one or more processors of a machine, cause the machine to perform operations comprising:
generating, by a second generative language model, a plurality of evaluation factors based on a first input prompt comprising:
a system instruction to generate evaluation factors for evaluating text output by a first generative language model;
a user query;
the text output by the first generative language model in response to the user query;
and
a reference response to the user query;
generating, by a third generative language model, an evaluation of the text output by the first generative language model, based on a second input prompt comprising:
the plurality of evaluation factors generated by the second generative language model;
the text output by the first generative language model in response to the user query; and
an instruction to evaluate the text output in response to the user query using the plurality of evaluation factors; and
outputting the evaluation generated by the third generative language model.

20. The non-transitory machine-readable medium of claim 19, wherein the instruction to evaluate the text output in the second input prompt instructs the third generative language model to:
generate detailed feedback for each of the plurality of evaluation factors; and
assign a score within a predetermined range based on how well the text output satisfies the plurality of evaluation factors.
